(19) United States
(12) Patent Application Publication
(10) Pub. No.: US 2006/0284857 A1
(43) Pub. Date: Dec. 21, 2006

(54) POWER-SAVING FUNCTION FOR TOUCH SCREEN DEVICE

(75) Inventor: Jang Geun OH, Suwon-si, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/422,533

(22) Filed: Jun. 6, 2006

(30) Foreign Application Priority Data
Jun. 16, 2005 (KR) 2005-0052065

(51) Int. Cl. G09G 5/00

(52) U.S. Cl. 345/173

(57) ABSTRACT

A power-saving function for a touch screen device provides efficient use of power, such as from a battery for a portable device. The touch screen device may include a sampling unit for digitizing an input to the touch screen. The power-saving function is provided with a battery level-monitoring unit for monitoring a battery level, and a sampling rate controller for controlling a sampling rate of the sampling unit based on the battery level monitored by the battery level-monitoring unit.

### BACKGROUND

This description relates to a power-saving function for a touch screen device that controls a sampling rate of a touch screen according to a remaining battery charge.

Personal Digital Assistant (PDAs) devices perform a number of functions, such as managing schedules and contact numbers. However, more advanced PDAs equipped with wireless communication modules provide Internet access, transmission and reception of E-mail, transmission and reception of fax, and transfers of other data types through a wireless communication network and/or through voice communication.

Some PDAs have integrated a special input scheme, such as using a touch screen instead of a large and heavy input device such as a keyboard, in the interest of reducing the overall size of the device. A touch screen is a device for inputting information to a data processing system, and can be combined for use with various types of display devices, such as CRTs and LCDs. A user can touch a menu or an icon displayed on a touch screen, or a user can press a number or a character in a signal input window that is shaped like a keypad displayed on the touch screen.

### SUMMARY

In one general aspect, a power-saving apparatus for a device having a touch screen and a sampling unit for digitizing an input to the touch screen includes a battery level-monitoring unit for monitoring a battery level, and a sampling rate controller for controlling a sampling rate of the sampling unit based on the battery level monitored by the battery level-monitoring unit.

Implementations may include one or more of the following features. For example, the power-saving apparatus may include a memory device for storing a correlation between a threshold value of the battery level and the sampling rate of the sampling unit, with the memory device being operatively connected to the sampling rate controller.

The sampling rate controller may be configured to provide first and second modes for setting the sampling rate. The first mode may set the sampling rate according to the battery level, and the second mode may set the sampling rate to a constant value. The second mode may be provided regardless of the battery level. The mode of the sampling rate controller may be selectively controllable by a user, or the sampling rate controller may be configured for automatically controlling the sampling rate based upon the battery level.

In another general aspect, a touch screen device includes a sampling unit for digitizing an input to the touch screen, and a power saving apparatus that includes a battery level-monitoring unit for monitoring a battery level of a battery, and a sampling rate controller of the sampling unit that is configured to control a sampling rate of the sampling unit based on the battery level monitored by the battery level-monitoring unit.

Implementations of this aspect may include one or more of the following features. For example, the sampling unit may include an Analog-to-Digital (AD) converter.

The touch screen device may include a memory device for storing a correlation between a threshold value of the battery level and the sampling rate of the sampling unit, with the memory device being operatively connected to the sampling rate controller.

The sampling rate controller may be configured to provide first and second modes for setting the sampling rate. The first mode may set the sampling rate according to the battery level, and the second mode may set the sampling rate to a constant value. The second mode may be provided regardless of the battery level. The mode of the sampling rate controller may be selectively controllable by a user, or the sampling rate controller may be configured for automatically controlling the sampling rate based upon the battery level.

The touch screen device may include the touch screen, and the battery providing a power supply.

In another general aspect, adjusting a sampling rate of a sampling unit in a touch screen device includes monitoring a battery level, and controlling the sampling rate of the sampling unit based on the battery level.

Implementations of this aspect may include one or more of the following features. For example, the sampling rate may be controlled by setting the sampling rate based on a correlation between a threshold value of the battery level and the sampling rate of the sampling unit stored in a look-up table.

The sampling rate may be controlled based on the battery level by comparing a threshold value for the battery level stored in a memory device with a current battery level, and setting the sampling rate to a new sampling rate based on the battery level stored in the memory device.

Other features will be apparent from the following description, including the drawings, and the claims.

### BRIEF DESCRIPTION OF THE DRAWINGS

FIG. 1 is a block diagram of an exemplary touch screen device.

FIG. 2 is a block diagram of a touch screen power-saving apparatus including a power optimization function.

FIG. 3 is a look-up table for storing a correlation between a battery level and a sampling rate of a sampling unit which is used for a power optimization function.

FIG. 4 is a flow diagram illustrating an operation of a touch screen power-saving apparatus having a power optimization function.

FIG. 5 is a flow diagram illustrating a touch screen power-saving method including a power optimization function.

FIG. 6 is a flow diagram illustrating a process for selecting a sampling rate of a sampling unit based on a battery level in a touch screen power-saving method including a power optimization function.

### DETAILED DESCRIPTION

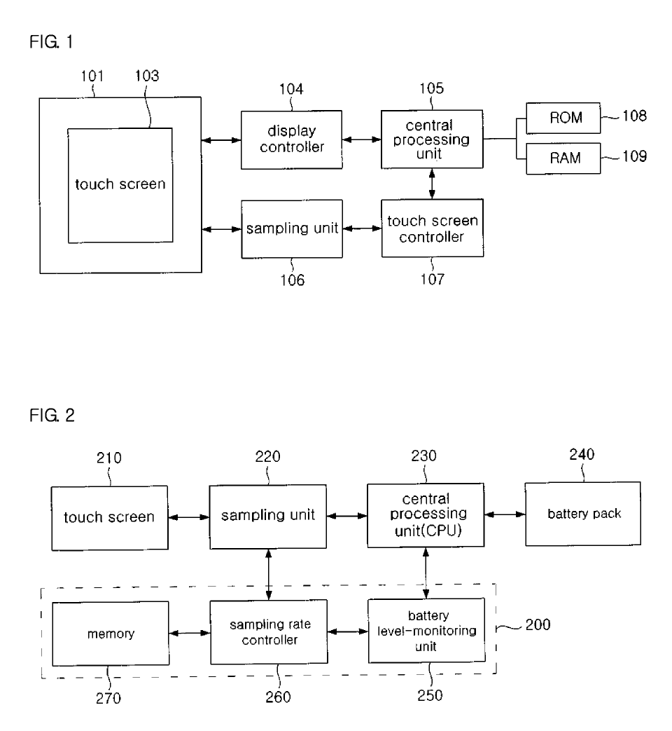

Referring to FIG. 1, a typical touch screen device includes various types of sensors attached under a screen surface. The sensors are provided for detecting and digitizing signals corresponding to inputs to the touch screen. A touch screen 103 is mounted on a display unit 101, and a display controller 104 controls the display of images on the display screen 103. A touch screen controller 107 controls power supplied to the touch screen 103, detects an analog value of a position touched on the touch screen 103, and transmits the detected analog value to a sampling unit 106. The sampling unit 106 converts analog information for the position touched on the touch screen 103 to a digital coordinate, and transmits the digital coordinate to a central processing unit 105 for execution of commands.

A Read-Only Memory (ROM) 108 for storing programs and code is connected to a central processing unit 105, and a Random Access Memory (RAM) 109 for providing a work area for storing various types of control data is also connected to the central processing unit 105.

Touch screens may be classified into various types of touch screens according to the operation principle of the device. For example, a touch screen device may include a touch screen of a matrix switch type, such as an optical sensor matrix type, a conductive film type, a variable capacitance type, and a metal fine wire-embedded type. A touch screen device may include a touch screen of an analog type, such as a conductive film type, a pressure sensor type, a supersonic reflection type, and a metal fine wire-embedded type.

The sampling unit 106 of the touch screen device increases a sampling rate in order to improve reliability through touch recognition of the touch screen 103. However, when the sampling unit 106 increases the sampling rate, power consumption also increases. Accordingly, it is useful to provide a device capable of reducing power consumption while also maintaining reliability as an efficient input device for a touch screen device.

One touch screen device utilizes a sleep mode to reduce the power consumption of the touch screen device. In the sleep mode, the sampling unit 106 decreases the sampling rate. When the touch screen 103 is touched, the touch screen device is switched into an active mode with a high sampling rate. In order to reduce power consumption, the sampling rate can be increased when the power mode of a portable device, such as a PDA, is an adapter mode in which AC power is supplied. The sampling rate can also be decreased when the power mode is a battery mode.

When the power mode is the battery mode, power consumption may increase as a result of the touch screen, and the operating time of the battery may be reduced. In addition, when a battery level is relatively low, performing sampling at a constant rate may hasten depletion of the remaining battery level.

A touch screen power-saving apparatus monitors the battery level of a portable data device, such as, for example, a notebook computer, a smart phone, a PDA, or similar device having a touch screen, and automatically controls the sampling rate of a sampling unit based on the monitored battery level, thereby reducing the power consumption.

In a first operating mode, a sampling rate of a sampling unit in the touch screen device is variably controlled based on the battery level to minimize power consumption. In general, this operating mode, which may be referred to as a sampling rate variation mode, may be used when the power mode of the computer system corresponds to a battery mode. Accordingly, the sampling rate of the sampling unit may be adjusted at a high sampling rate, a medium sampling rate or a low sampling rate according to the battery level.

In a second operating mode, in which the sampling rate of a sampling unit in a touch screen device is constantly maintained regardless of the battery level, a power-saving function is not used. This mode may be employed when AC power is applied to the computer system. The second mode may be selected so as to increase the sampling rate in order to improve performance of the computer system.

The first mode (i.e., the sampling rate variation mode) may be selected by a user command even when a portable device is switched from an AC adapter mode to a battery mode, or the portable device is in the adapter mode.

Referring to FIG. 2, a touch screen device having the touch screen power-saving apparatus 200 includes a sampling unit 220 for digitizing input of a touch screen 210, a battery level-monitoring unit 250 for monitoring a battery level, and a sampling rate controller 260 for automatically controlling the sampling rate of the sampling unit 220 based on the monitoring results received from the battery level-monitoring unit 250. The sampling unit 220 of the touch screen device can include an Analog-to-Digital (AD) converter. If the sampling unit 220 does not include an integral AD converter, the AD converter may be additionally provided between the touch screen 210 and a central processing unit 230. The power-saving apparatus 200 may be a separate device or a subcomponent of the CPU 230, sampling unit 220 or other component of the portable device.

The battery level-monitoring unit 250 continuously checks the battery level. The battery level-monitoring unit 250 is connected to the central processing unit 230 of the portable device, and the central processing unit 230 is connected to a battery pack 240. The battery level-monitoring unit 250 may receive information for the battery level from an Operating System (OS). If there is a change in the battery level, the sampling rate controller 260 searches for a look-up table stored in a memory 270 in order to determine an appropriate sampling rate.

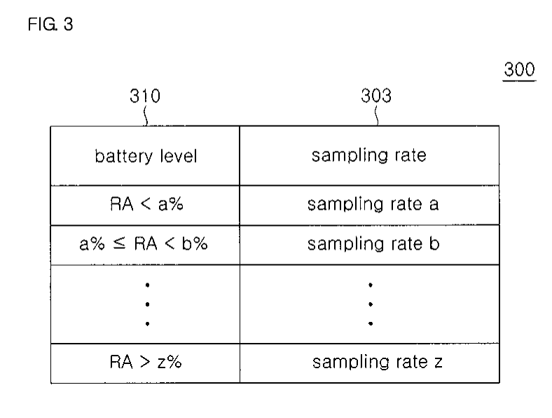

The look-up table in the memory 270 may store predefined or user-defined relationships between the battery level and the sampling rate of the sampling unit 220. The memory 270 also may store one or more threshold values for use in determining when to adjust the sampling rate according to the battery level. The memory 270 may include, for example, one ore more storage mediums, such as a Random Access Memory (RAM), a Read-Only Memory (ROM), an Electrically Erasable Programmable Read-Only Memory (EEPROM), and a flash EEPROM. Referring to FIG. 3, an exemplary memory 300 includes a look-up table defining the relationships between the battery level and the sampling rate of the sampling unit 220. The memory 300 includes the look-up table which stores values representing the battery level 310, such as the Remaining Amount (RA) of battery power. The look-up table also includes the sampling rate 303 corresponding to each battery level 310. For power-saving modes, a higher sampling rate is generally set as the battery level increases, and a lower sampling rate is generally set as the battery level decreases.

For example, when the sampling rate is adjusted at three types of rates according to the battery level, it is possible to set a first threshold value to a battery level of 60% and to set a second threshold value to a battery level of 90%. Accordingly, when the battery level is less than 60%, the sampling rate is set to a low sampling rate, such as approximately 40-50 points per seconds. When the battery level is higher than 60% and less than 90%, the sampling rate is set to a medium sampling rate of approximately 100-150 points per second. When the battery level exceeds 90%, the sampling rate is set to a high sampling rate of approximately 190-200 points per seconds.

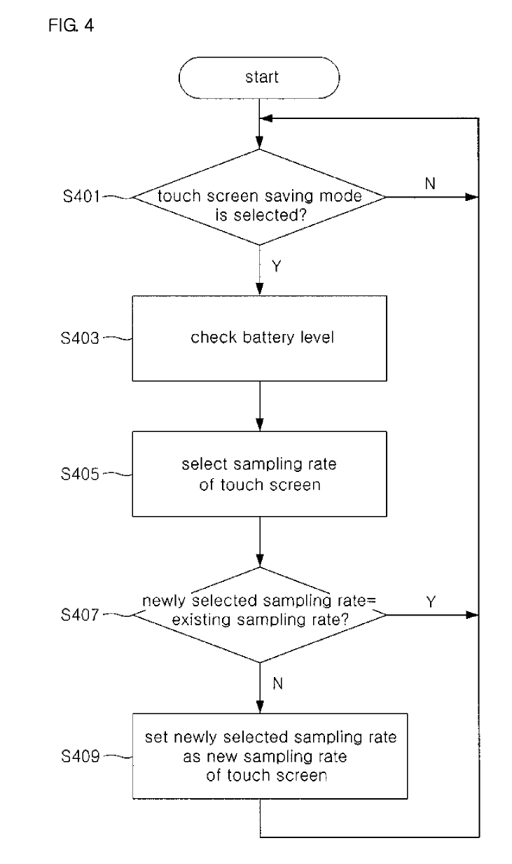

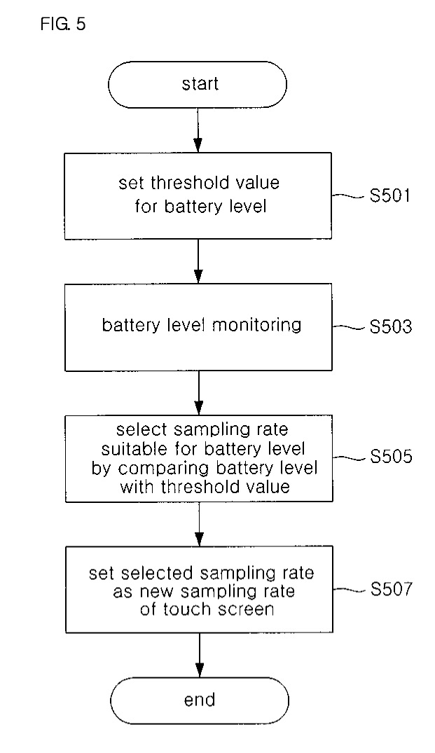

Referring to FIG. 4, the sampling rate controller 260 determines if the sampling rate variation mode has been selected (S401) in an exemplary operation. If the portable device is switched from the AC adapter mode to the battery mode, the sampling rate variation mode may be used in order to reduce the battery power consumption. However, even if the device is still in the AC adapter mode, the sampling rate variation mode may be used in order to reduce the processing load. If AC power has been supplied to the portable device, the sampling rate controller 260 determines if the sampling rate variation mode has been selected by a user. If the sampling rate variation mode has been selected by the user, the sampling rate variation mode is activated. Alternatively, if the sampling rate variation mode is inactive, a mode is maintained in which sampling is performed at a single sampling rate without respect to battery level. If the sampling rate variation mode has been selected, the central processing unit 230 receives information for the battery level from the OS of the portable device, and transmits the received information to the battery level-monitoring unit 250. The battery level-monitoring unit 250 continuously checks the battery level (S403).

The sampling rate controller 260 then receives the information for the battery level from the battery level-monitoring unit 250, searches for the look-up table stored in the memory 270, and selects a sampling rate for a specific battery level (S405). Next, the sampling rate controller 260 determines if the sampling rate selected based on the current battery level is equal to an existing sampling rate (S407). If the selected sampling rate is not equal to the existing sampling rate, the sampling rate controller 260 sets the newly selected sampling rate as a new sampling rate of the touch screen (S409). However, when the selected sampling rate is equal to the existing sampling rate, the sampling rate controller 260 does not change the existing sampling rate. The central processing unit 230 controls the sampling rate controller 260 to adjust the sampling rate of the sampling unit 220, and computes a coordinate of an input position based on the digital value received from the sampling unit 220.

Referring to FIG. 5, the power-saving function of the touch screen is dependent upon results from monitoring the remaining amount of the battery mounted on the portable device. The power-saving function automatically controls the sampling rate of the sampling unit in the touch screen device according to the monitoring results. In order to adjust the sampling rate of the sampling unit based on the battery level, various relationships between the battery level and the sampling rate of the sampling unit are stored in the look-up table of the memory in the portable device (S501). Threshold values based on the battery levels are stored in the look-up table in connection with the sampling rates of the sampling unit. Thereafter, the remaining amount of the battery is monitored (S503). Next, a sampling rate suitable for and corresponding to the battery level is automatically selected (S505). In order to obtain a sampling rate suitable for a specific battery level, the look-up table stored in the memory is used. For power-saving, a higher sampling rate is set as the battery level increases, and a lower sampling rate is set as the battery level decreases. The selected sampling rate is set as a new sampling rate of the touch screen based on the battery level (S507).

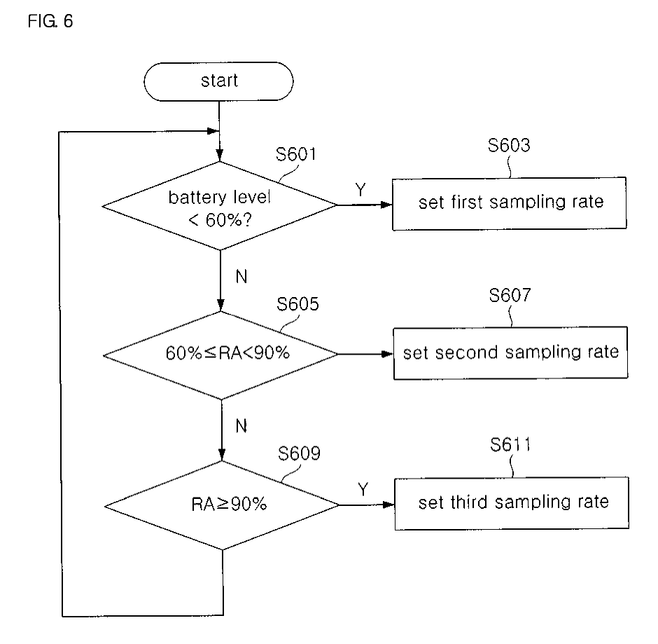

Referring to FIG. 6, an exemplary process for determining a sampling rate suitable for a random battery level compares the battery level to a number of thresholds and sets the sampling rate accordingly. For example, a first threshold value of the battery level corresponds to 60% and a second threshold value of the battery level corresponds to 90%. Initially, when information for the battery level is received from the OS, a determination is made as to whether the battery level is less than the first threshold value (60%) (S601). If the battery level is less than the first threshold value, a first sampling rate (i.e., a relatively low sampling rate) is set as the sampling rate of the touch screen (S603). If the battery level is higher than or equal to the first threshold value (60%) and is lower than the second threshold value (90%) (S605), a second sampling rate (i.e., a relatively medium sampling rate) is set to the sampling rate of the touch screen (S607). If the battery level is higher than the second threshold value (S609), a third sampling rate (i.e., a high sampling rate) is set to the sampling rate of the touch screen (S611). However, the threshold values of the battery level and corresponding sampling rates may be varied by the user and/or include alternative threshold values and battery level intervals.

Accordingly, a sampling rate of a touch screen is adjusted according to the battery level, so that power consumption can be reduced while maintaining the processing reliability of input(s) to the touch screen. In addition, the performance of the touch screen can be optimized with the power-saving function.

Various modifications, additions and substitutions are possible, without departing from the scope and spirit of the aforementioned implementations as described in the accompanying claims.

What is claimed is:

1. A power-saving apparatus for a device having a touch screen and a sampling unit for digitizing an input to the touch screen, the apparatus comprising:
a battery level-monitoring unit for monitoring a battery level; and
a sampling rate controller for controlling a sampling rate of the sampling unit based on the battery level monitored by the battery level-monitoring unit.

2. The apparatus as claimed in claim 1, further comprising a memory device for storing a correlation between a threshold value of the battery level and the sampling rate of the sampling unit, the memory device being operatively connected to the sampling rate controller.

3. The apparatus as claimed in claim 1, wherein the sampling rate controller is configured for providing a first mode for setting the sampling rate and a second mode for setting the sampling rate, wherein the first mode sets the sampling rate according to the battery level, and the second mode sets the sampling rate to a constant value.

4. The apparatus as claimed in claim 3, wherein the second mode is provided regardless of the battery level.

5. The apparatus as claimed in claim 3, wherein the mode of the sampling rate controller is selectively controllable by a user.

6. The apparatus as claimed in claim 1, wherein the sampling rate controller is configured for automatically controlling the sampling rate based upon the battery level.

7. A touch screen device, the device comprising:
a sampling unit for digitizing an input to the touch screen; and
a power saving apparatus, wherein the power saving apparatus includes:
a battery level-monitoring unit for monitoring a battery level of a battery; and
a sampling rate controller of the sampling unit, the sampling rate controller being configured for controlling a sampling rate of the sampling unit based on the battery level monitored by the battery level-monitoring unit.

8. The device as claimed in claim 7, wherein the sampling unit includes an Analog-to-Digital (AD) converter.

9. The device as claimed in claim 7, further comprising a memory device for storing a correlation between a threshold value of the battery level and the sampling rate of the sampling unit, the memory device being operatively connected to the sampling rate controller.

10. The device as claimed in claim 7, wherein the sampling rate controller is configured for providing a first mode for setting the sampling rate and a second mode for setting the sampling rate, wherein the first mode sets the sampling rate according to the battery level, and the second mode sets the sampling rate to a constant value.

11. The device as claimed in claim 10, wherein the second mode is provided regardless of the battery level.

12. The device as claimed in claim 10, wherein the mode of the sampling rate controller is selectively controllable by a user.

13. The device as claimed in claim 10, wherein the sampling rate controller is configured for automatically controlling the sampling rate based upon the battery level.

14. The device as claimed in claim 7, further comprising:
the touch screen; and
the battery providing a power supply.

15. A method for adjusting a sampling rate of a sampling unit in a touch screen device, the method comprising:
monitoring a battery level; and
controlling the sampling rate of the sampling unit based on the battery level.

16. The method as claimed in claim 13, wherein controlling the sampling rate comprises setting the sampling rate based on a correlation between a threshold value of the battery level and the sampling rate of the sampling unit stored in a look-up table.

17. The method as claimed in claim 13, wherein controlling the sampling rate of the sampling unit based on the battery level comprises:
comparing a threshold value for the battery level stored in a memory device with a current battery level; and
setting the sampling rate to a new sampling rate based on the battery level stored in the memory device.
